(19) United States
(12) Patent Application Publication
(10) Pub. No.: US 2005/0239365 A1
(43) Pub. Date: Oct. 27, 2005

(54) Method and apparatus for repairing plasma display electrode

(75) Inventor: Tomomi Hiraoka, Izumi (JP)

Correspondence Address: MCGINN & GIBB, PLLC, 8321 OLD COURTHOUSE ROAD, SUITE 200, VIENNA, VA, 22182-3817, US

(73) Assignee: Pioneer Plasma Display Corporation, Izumi (JP)

(21) Appl. No.: 11/089,444

(22) Filed: Mar. 25, 2005

(30) Foreign Application Priority Data
Mar. 31, 2004 (JP) 2004-106887

(51) Int. Cl. H01J 9/50

(52) U.S. Cl. 445/61

(57) ABSTRACT

The plasma display electrode repair method and electrode repair apparatus adjust an electrically conductive paste including Ag particles of the adequate size to the adequate viscosity, and linearly coat on the electrode repair zones with this electrically conductive paste by means of a dispenser coating apparatus. The distal end of the nozzle for paste coating is set to the adequate height above the surface of the PDP glass substrate and the disconnection defect zones can be coated with the paste at the adequate speed. Furthermore, a semiconductor laser is provided and drying and baking of the paste after coating can be conducted rapidly. As a result, the disconnection defects that appeared in the electrode wiring formed on the glass substrate in the PDP fabrication process can be rapidly repaired. Therefore, highly reliable repair can be conducted rapidly, thereby significantly contributing to an increase of the PDP yield.

### BACKGROUND OF THE INVENTION

1. Field of the Invention

The present invention relates to a plasma display electrode repair method and electrode repair apparatus for coating and baking an electrically conductive paste for repair on a repair zone so as to repair the disconnection of metal electrodes formed on a glass substrate for a plasma display.

2. Description of the Related Art

In recent years, plasma display panels (hereinafter referred to as PDP) having a multiplicity of display cells have attracted attention as thin and large-screen displays. A PDP realizes a color display by exciting fluorescent substances coated on the inner surface of discharge cells and emitting red, green, and blue fluorescent colors with UV rays generated by gas discharge and obtaining the emission of three primary colors.

FIG. 7 is a perspective view illustrating the panel structure of a conventional surface discharge AC (Alternating-Current) PDP. This PDP 100 includes a first substrate 110 on the display side and a second substrate 120 disposed opposite the first substrate 110.

In the first substrate 110, a plurality of linear surface discharge electrodes 112 are formed on the surface of a first glass substrate 111. Surface discharge electrodes 112 are formed so as to be parallel to each other, and the discharge is generated on the surface where a voltage is applied between the electrodes. Transparent electrodes such as ITO (Indium Tin Oxide) are used for the surface discharge electrodes 112. Since the transparent electrodes have insufficient electric conductivity, bus electrodes 113 are formed in the portions that will not adversely affect the emission. A first transparent dielectric layer 114 is formed so as to cover the first glass substrate 111, surface discharge electrodes 112, and bus electrodes 113. A black matrix 115 for delineating the pixels is formed as a lattice on the surface of the first transparent dielectric layer 114. Then, a second transparent dielectric layer 116 is formed so as to cover the first transparent dielectric layer 114 and black matrix 115, and a protective layer 117 is formed to cover the surface of the second transparent dielectric layer.

In the second substrate 120, a plurality of address electrodes 122 are formed with a spacing therebetween on a second glass substrate 121. A dielectric layer 123 is formed so as to cover the second glass substrate 121 and address electrodes 122 and then red, green, and blue fluorescent layers 125 are formed. The fluorescent layers 125 are partitioned with separation ribs 124, and the fluorescent layers 125 are formed so as to cover the side surface of the separation ribs 124 and the surface of the dielectric layer 123. Further, a discharge gas (not shown) is enclosed between the first substrate 110 and second substrate 120.

Scanning pulses are successively applied to a pair of bus electrodes 117, and address pulses are applied to the address electrodes 122 selected synchronously therewith. Once such scanning has been conducted over the entire surface of the PDP, sustained discharge is conducted over the entire surface of the panel and color light emission is obtained.

Such operations are conducted in a plurality of subfields having the prescribed number of light emissions corresponding to the digitalized gradation data within a field period of 1/60 sec so that a color image is displayed.

The electrodes of the PDP thus play an important role for displaying images and represent one of the important elements ensuring image quality. Further, fine electrode patterns have to be formed in the PDP. Examples of the formation methods include vapor deposition, sputtering, photolithography using a photosensitive electrically conductive paste, and pattern printing by screen printing using an electrically conductive paste.

Inspection and repair of disconnection and short circuiting of electrode wiring is conducted in the course of the electrode formation process and upon completion of the process. Image inspection by image processing and electric continuity inspection in which continuity is electrically inspected have been mainly used as the inspection methods. With the former inspection method, the electrode pattern is introduced into a personal computer by using a CCD (Charge-Coupled Device) camera and the defect zones are judged by conducting processing according to an algorithm such as an adjacent comparison method, design rule method, or streaming method. With the latter process, electric continuity is inspected by contacting electrically conductive probes with two predetermined locations of the electrode wiring and applying a voltage between the probes.

When disconnection defects are detected in the electrode wiring by the above-descried inspection, an electrode repair process is implemented after the inspection process and the disconnected zone is repaired. An example of the electrode repair method is disclosed in Japanese Patent No. 2983879. With this method, an apparatus is employed that includes a coating needle movable in the vertical direction and a container for supplying a repair paste, the coating needle is inserted into the container filled with the repair paste, and the repair paste that adhered to the distal end of the needle is transferred onto the disconnection defects portion. The transferred repair paste is in the form of spots with a size about that of the distal end of the coating needle. Further, Japanese Patent Kokai No. 11-108848 discloses a method for repairing the disconnection within a short time. With this method the repair range of the disconnection defect portion can be designated with a simple command and spot-like coating is then conducted the number of times sufficient to connect the wiring in the disconnection zone by the coating method similar to that disclosed in Japanese Patent No. 2983879, while offset moving the coating needle or the table based on the position information of the repair range.

However, with the method described in Japanese Patent No. 2983879, operations are required to adhere the paste to the distal end of the coating needle and to transfer the paste onto the defect zone. Further, in each single paste transfer operation, the coating of the paste has a spot-shape. Therefore, when the disconnection range is long, the coating has to be conducted so that the spot-like coated shapes overlap forming a line. Furthermore, because the coated spot-like paste has to have a width less than a line width of the electrode, a long time is required to sufficiently repair the disconnection having the length longer than the line width.

By contrast, there is a coating method employing a dispenser system which is one of the methods for coating of a paste within a short time. This coating method is mainly used for coating seal frits and fluorescent substances in the field of image display devices. For example, Japanese Patent No. 3159909 discloses a process of using a glass frit paste produced by finely powdering a non-crystalline glass frit powder to a size of 3.5 μm and coating of the paste with a dispenser having a nozzle inner diameter of 150-600 μm. The film thickness of the coated frit is from several tens to several hundreds of μm and the width thereof is several hundreds of μm.

Further, Japanese Patent Kokai No. 2003-317618 discloses a coating method by which grooves formed between the separation ribs for partitioning the discharge spaces on the rear surface plate of a PDP are filled with a fluorescent paste by a dispenser system.

However, the following problems are associated with the above-described conventional technology. The dimensions of the repaired electrodes for the plasma display need to have a thickness of about several μm and a width of about several tens of μm. Therefore, the coating method using a dispenser system is difficult to obtain the dimensional accuracy, and therefore the electrode repair is difficult to conduct with the dispenser system. In order to repair multiple electrode wirings formed on the glass substrate of a PDP, the repair coating has to be conducted so as to obtain a coating of the same size and the same electric conductivity as the wiring electrode in the zones where no partition such as separation rib is provided. However, for example, if a localized difference in thickness is present, there is a risk of adversely affecting coatability in batch coating over the entire surface such as printing and coating with a coater in subsequent processing. Furthermore, if the width of the repaired electrode is increased, the gap clearance between the adjacent electrodes decreases and can produce an adverse effect on the electrode reliability.

### SUMMARY OF THE INVENTION

It is an object of the present invention to provide a PDP electrode repair method and an electrode repair apparatus for rapidly repairing the disconnection defects occurring in electrode wirings formed on a glass substrate in the PDP manufacturing process.

According to one aspect of the present invention, there is provided an electrode repair method for a plasma display which includes placing a glass substrate of the plasma display on a stage, specifying a disconnection defect zone of an electrode by observing a surface of the glass substrate of the plasma display, measuring a distance H between a distal end of a coating nozzle section in a dispenser coating apparatus including the coating nozzle section and a syringe section and the surface of the glass substrate of the plasma display, disposing the coating nozzle section so that a distance (H−T) obtained by subtracting a thickness T of the electrode from the distance H becomes a predetermined value or more, linearly coating the disconnection defect zone of the electrode with an electrically conductive paste by ejecting the paste from the coating nozzle section, while scanning the dispenser coating apparatus in a horizontal direction, and repairing the disconnection defect zone of the electrode by drying and baking the electrically conductive paste.

With the present invention, the distal end of the paste coating nozzle can be set to the adequate height above the surface of the PDP glass substrate and the disconnection defect zone can be coated with the paste at the adequate speed. Furthermore, the baking apparatus is provided and drying and baking of the paste after coating can be rapidly conducted. As a result, highly reliable repair can be rapidly conducted.

According to another aspect of the present invention, there is provided an electrode repair apparatus for a plasma display including a stage for placing a glass substrate of the plasma display, a camera for picking up an image of a surface of the glass substrate of the plasma display, a display unit for displaying the image picked up with the camera, a dispenser coating apparatus including a syringe section filled with an electrically conductive paste and a coating nozzle section for ejecting the electrically conductive paste, a pressurization control apparatus for pressurizing an inside of the syringe section and ejecting the electrically conductive paste from the coating nozzle section, a measurement device for measuring a distance between a distal end of the coating nozzle section and a surface of the glass substrate of the plasma display, a baking device for drying and baking the electrically conductive paste after coating, a drive apparatus for driving the camera, the dispenser coating apparatus, the measurement device, and the baking apparatus in a vertical direction and a horizontal direction, and a control apparatus for controlling the drive apparatus so as to linearly coat a disconnection defect zone of an electrode on the surface of the glass substrate of the plasma display with the electrically conductive paste.

With the present invention, when the disconnection defect zone on the surface of the PDP glass substrate is repaired by using an electrically conductive paste, the electrically conductive paste including Ag particles of the adequate size can be adjusted to the adequate viscosity, the distal end of the paste coating nozzle can be set to the adequate height above the surface of the PDP glass substrate, and the disconnection defect zone can be coated with the paste at the adequate speed. Furthermore, the baking apparatus is provided and drying and baking of the paste after coating can be rapidly conducted. As a result, highly reliable repair can be conducted rapidly, thereby significantly contributing to an increase of the PDP yield.

### BRIEF DESCRIPTION OF THE DRAWINGS

FIG. 1 is a schematic view of the electrode repair apparatus of the embodiment of the present invention;

FIG. 2 illustrates the operation of measuring the gap between the coating nozzle and substrate surface of the embodiment of the present invention;

FIG. 3 illustrates the operation of coating of the repair paste of the embodiment of the present invention;

FIG. 4 illustrates the operation of drying and baking the paste after coating of the embodiment of the present invention;

FIG. 5 illustrates the relationship between the inner diameter of the coating nozzle, coating speed, and coating width of a first example of the present invention;

FIG. 6 illustrates the relationship between the paste viscosity, coating pressure, and coating width of a second example of the present invention; and

FIG. 7 is a perspective view illustrating the structure of a color plasma display of an AC surface discharge type.

### DETAILED DESCRIPTION OF THE INVENTION

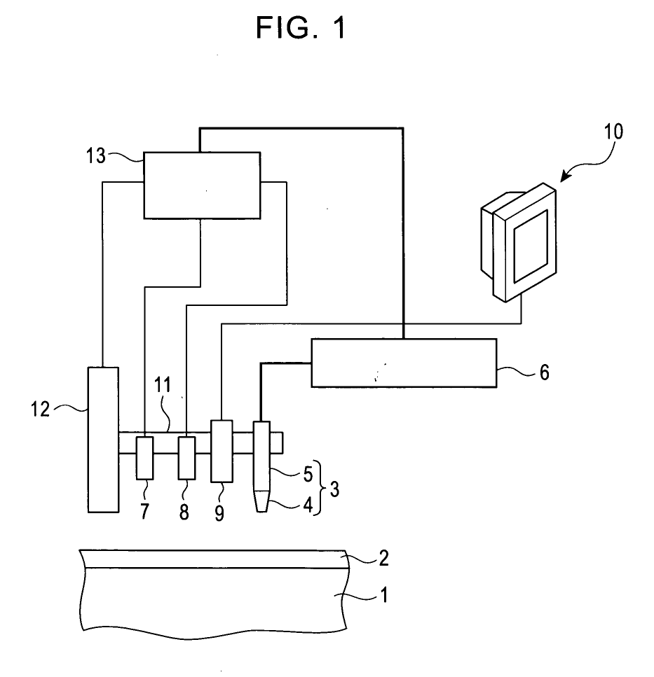

The embodiments of the present invention will be hereinafter described in detail with reference to the accompanying drawings. FIG. 1 is a block diagram illustrating an electrode repair apparatus used in the PDP electrode repair method of the present embodiment. It should be noted that, as shown in FIG. 1, a PDP glass substrate 2 is placed on a stage 1 of the electrode repair apparatus used for the PDP electrode repair method of the present embodiment. The repair of the electrode present on the surface of the PDP glass substrate 2 is conducted by coating the disconnection zones with a repair paste by means of a dispenser coating apparatus 3 having a coating nozzle 4 and a syringe 5. In the dispenser coating apparatus 3, a pressure is applied to the repair paste filled in the syringe 5 with a pressurization control apparatus 6 and the repair paste is ejected from the distal end of the nozzle. The operation of the pressurization control apparatus 6 is controlled with a control unit 13. The dispenser coating apparatus 3 is disposed on an arm 11 together with a semiconductor laser 8 for drying and baking the repair paste coating on the surface of the PDP glass substrate 2 and an observation CCD camera 9 for observing the electrode disconnection zones on the surface of the PDP glass substrate 2. The operation of the semiconductor layer is controlled with the control unit 13. The observation results obtained with the observation CCD camera 9 are outputted to an observation monitor 10. A height detector 7 is also provided on the arm 11 with the object of controlling the height of the distal end section 4 of the coating nozzle above the surface of the electrodes present on the PDP glass substrate 2, and the operation of the height detector is controlled with the control unit 13. The arm 11 is connected to an XYZ drive apparatus 12 and can be moved in X and Y directions (horizontal direction) and a Z direction (vertical direction) with respect to the PDP glass substrate 2. The operation of the XYZ drive apparatus 12 is controlled by the control unit 13.

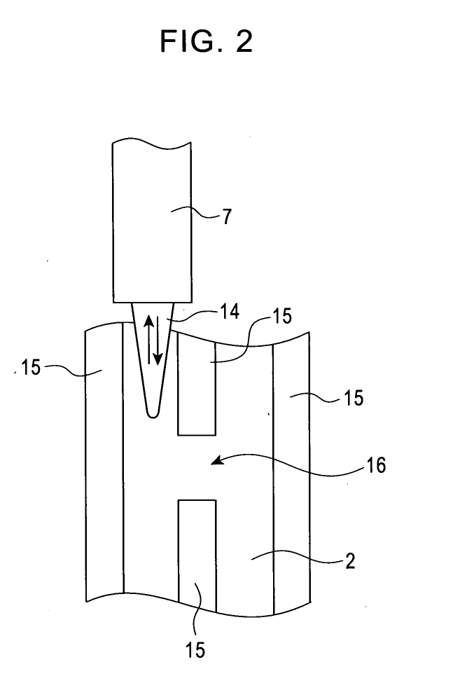

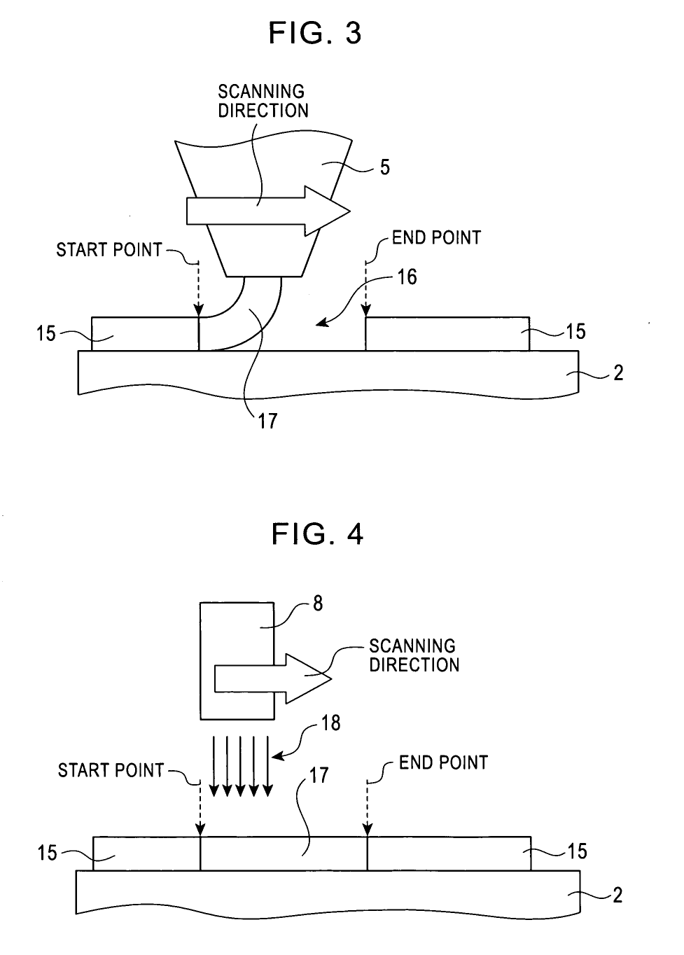

The operation of the electrode repair method for a PDP of the present embodiment having the above-described configuration will be described below. FIG. 2 is a schematic drawing illustrating the operation of measuring the height of coating nozzle above the surface of the PDP glass substrate by using the PDP electrode repair method of the present embodiment. Furthermore, FIG. 3 is a schematic diagram illustrating the operation of coating of the repair paste, and FIG. 4 is a schematic diagram illustrating the operations of drying and baking the coating paste. First, the surface of the PDP glass substrate 2 placed on the stage 1 is observed with the observation CCD camera 9 and the disconnection zones are specified. The disconnection zones can be easily specified by the images outputted by the observation CCD camera 9 to the observation monitor 10. In the present embodiment, it is assumed that the disconnection zone of an address electrode formed on the rear panel of the PDP will be repaired. The line width of the address electrode is 100 μm and the thickness thereof is 10 μm. Then, as shown in FIG. 2, the height of the coating nozzle 4 above the surface of the PDP glass substrate 2 is measured by irradiating with a laser beam 14 the substrate surface between the electrodes on the PDP glass substrate 2 in the vicinity of a disconnection defect zone 16 of the address electrode 15 and detecting the intensity of the reflected light. Then, the disconnection zone is coated with the repair paste by means of the dispenser coating apparatus 3. As shown in FIG. 3, this coating with the repair paste 16 is conducted by ejecting the repair paste 17 onto the disconnection defect zone 16 of the address electrode 15 to be repaired, while horizontally scanning (direction shown by an arrow symbol in FIG. 3) the coating nozzle 4 from one end of the disconnection portion to the other end. At this time, the coating start point and coating end point are set on the image outputted to the observation monitor 10. In the present embodiment, in order to make a line width of the coating of the repair paste 17 equal to the address electrode 15, the inner diameter of the coating nozzle 4 is 30 μm, the ejection pressure of the paste is 0.05 MPa, the height of the coating nozzle 4 above the substrate surface is 40 μm, and the scanning speed of the coating nozzle 4 during the ejection of the repair paste 17 is 0.5 mm/sec.

The syringe 5 of the dispenser coating apparatus 3 is filled in advance with the repair paste 17. The repair paste 17 includes electrically conductive particles as the main component and also includes an organic binder and a solvent. Ag particles with a mean particle diameter of 0.5 μm, which have good electric conductivity, are used as the electrically conductive particles. Furthermore, a cellulose resin, which is one of thermoplastic resins and can be baked at a low temperature, is used as the organic binder. Terpineol is used as the solvent to adjust viscosity, improve coatability, and improve dispersivity, and the viscosity of the repair paste 17 is adjusted to 10 Pa·sec. It is preferred that at least one type of fine metal particles of Ru, Cr, Fe, Co, Mn, Cu or fine particles of oxides thereof be added to the repair paste 17 to provide it with gray color. Such transition to gray color makes it possible to reduce the external light reflection when a bus electrode formed on the front panel of the PDP is repaired. As a result, the repair paste 17 can be commonly used for the disconnection defect zones of the electrodes on the front panel and rear panel of the PDP and the repair of the disconnection defect zones of the electrodes on the front panel and rear panel of the PDP can be conducted with the same equipment.

Then, as shown in FIG. 4, the semiconductor laser 8 is scanned horizontally (direction shown by the arrow symbol in FIG. 4) and drying and baking are conducted by irradiating the repair paste 17 with the laser beam 18. At this time, the laser irradiation start point and laser irradiation end point are set on the image outputted to the observation monitor.

Accordingly, with the present embodiment, the disconnection defect zone 16 of the address electrode 15 can be repaired to have the line width similar to the address electrode 15. The rear panel of the PDP that was repaired by the PDP electrode repair method of the present embodiment shows sufficient electric conductivity in the open short inspection process of the electrodes conducted after the electrode repair process. Furthermore, the PDP assembled by using the rear panel of the PDP where the disconnection defect zone was repaired by the above-described method shows characteristics similar to a PDP using a rear panel having no disconnection defect (no repair is thus required). It should be noted that, in the present embodiment, the dispenser coating apparatus 3, height detector 7, semiconductor laser 8, and observation CCD camera 9 are disposed on the common arm 11 and moved simultaneously, but the present invention is not limited to this embodiment, and those units may be moved independently from each other. Furthermore, in the present embodiment, an example of repairing the disconnection zone of the address electrode formed on the rear panel of the PDP was described, but the present invention is not limited to this embodiment, and can be also applied to repairing the disconnection zone of bus electrodes or the like formed on the front panel of the PDP.

It should be noted that, in the present embodiment, an example of using the laser beam as the height detector 7 was described, but the present invention is not limited to this embodiment, and other light sources, for example an LED (Light Emitting Diode) may be also used. Furthermore, a contact sensor may be used instead of the optical sensor employing a laser beam. For example, a Z axis operation unit movable in the vertical direction with respect to the coating nozzle 4 is provided in the contact sensor, and a probe is provided in the Z axis operation unit. This probe can vertically move to a certain extent with respect to the Z axis operation unit along a guide. Further, a sensor for detecting the vertical movement of the probe on the guide is provided in the Z axis operation unit. This sensor is fixed to the Z axis operation unit and includes, for example, a first pair of light emitting and receiving sections and a second pair of light emitting and receiving sections. Furthermore, in an initial condition, the Z axis operation unit is located in a predetermined position with respect to the coating nozzle 4, the first pair of the light emitting and receiving sections is covered with a lower end section of a reflecting plate, and the second pair of the light emitting and receiving sections is positioned above an upper end of the reflecting plate. Therefore, the light emitted from the light emitting section of the first pair of the light emitting and receiving sections is reflected by the reflecting plate and detected by the light receiving section. On the other hand, because the light emitted from the light emitting section of the second pair of the light emitting and receiving sections is not reflected by the reflecting plate, it is not detected by the light receiving section. If the probe is lowered by lowering the Z axis operation unit from this initial condition, when the distal end of the probe is brought into contact with the substrate surface, the probe is stopped with respect to the substrate. Therefore, the probe rises relative to the Z axis operation unit. At this time, the reflecting plate fixed to the probe also rises following the relative rise of the probe, the first pair of the light emitting and receiving sections is positioned lower than the lower end of the reflecting plate, and the second pair of the light emitting and receiving sections is covered with the upper end section of the reflecting plate. As a result, in the first pair of the light emitting and receiving sections, the reflected light is not detected, whereas in the second pair of the light emitting and receiving sections, the reflected light is detected. The rise of the probe is thus detected. Further, the position of the probe at the time when the distal end of the probe was brought into contact with the substrate surface is detected and the height of the substrate surface is calculated by finding the position of the Z axis at this time from the lowering degree of the Z axis operation unit and finding the position of the Z axis operation unit with respect to the coating nozzle 4. Further, in the present embodiment, a semiconductor laser was used as means for drying and baking the repair paste 17, but the present invention is not limited to this embodiment and other laser beam sources such as a YAG laser may be used. Moreover, a thermal heater such as a thermoelectric wire may be used, but it is preferable to use a laser light source having capability to cause localized heating.

The inner diameter of the coating nozzle 4 is preferably 20 μm or more to less than 60 μm. If it is less than 20 μm, the nozzle can be easily clogged. If the inner diameter of the coating nozzle 4 is 60 μm or more, the coating width of the repair paste 17 is difficult to reduce to about 100 μm. It is further preferred that the inner diameter of the coating nozzle 4 be less than 50 μm. If it is 50 μm or more, the fluctuation of the coating width is easily increased. The viscosity of the repair paste 17 is preferably 10 to 50 Pa·sec. If the viscosity is less than 10 Pa·sec, the ejection rate of the repair paste 17 becomes too large, and thus the coating width increases. Accordingly, the adjacent electrodes are easily short circuited. If the viscosity exceeds 50 Pa·sec, the nozzle can be easily clogged.

The height of the coating nozzle 4 above the substrate surface is preferably 20 μm or more to less than 100 μm. If the height is less than 20 μm, there is a risk that the coating nozzle 4 damages the electrode surface. If the height is 100 μm or more, the coating process becomes intermittent or the coating is not carried out and good coating condition is difficult to obtain. It is even further preferred that the height of the coating nozzle 4 above the substrate surface be less than 70 μm. If the height is 70 μm or more, then good coating condition is difficult to obtain unless the coating speed is reduced to 0.5 mm/sec or less.

The mean particle diameter of Ag particles contained in the repair paste 17 is preferably 0.1 μm or more to less than 1.0 μm. If the mean particle diameter of Ag particles is less than 0.1 μm, the paste thickness decreases as well as the paste width increases during baking and the adjacent electrodes can be easily short circuited. If the mean particle diameter is 1.0 μm or more, the nozzle can be easily clogged. It is even more preferred that the mean particle diameter of Ag particles be 0.3 μm or more. If the mean particle diameter of Ag particles is less than 0.3 μm, the paste may easily spread to a certain extent during baking.

### FIRST EXAMPLE

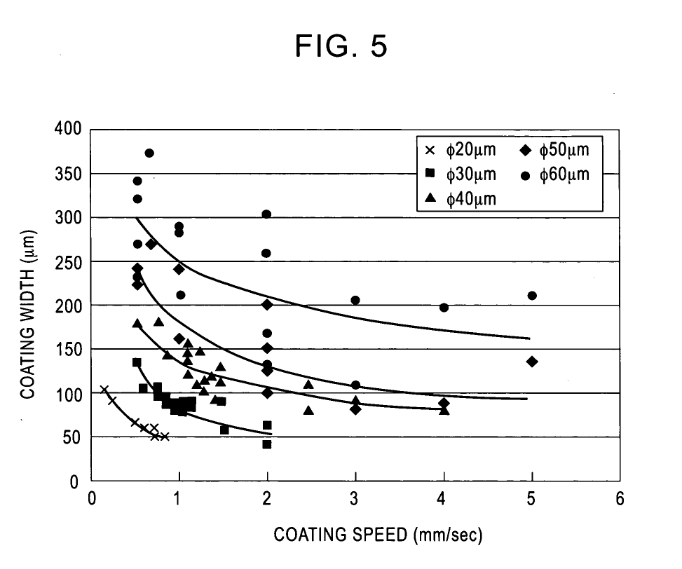

The coating condition was evaluated by varying the inner diameter of the coating nozzle 4 and the scanning speed (hereinafter referred to as “coating speed”) of the dispenser coating apparatus 3 during coating of the repair paste 17 in the PDP electrode repair method of the present embodiment. The width and thickness of the address electrode 15 that was repaired were 100 μm and 10 μm, respectively, the height of the coating nozzle 4 from the substrate surface was 40 μm, the pressure applied to the syringe 5 for ejecting the paste (hereinafter referred to as “coating pressure”) was 0.03 MPa, and the paste viscosity was 10 Pa·sec. The inner diameter of the coating nozzle 4 was varied as 20, 30, 40, 50, and 60 μm. Furthermore, the coating speed was varied to a maximum of 6 mm/sec on respective inner diameters of the coating nozzle. 4. The coating condition was evaluated by observing the image from the observation CCD camera 9 with the observation monitor 10 and by measuring the coating width. The results are shown in FIG. 5. In FIG. 5, the abscissa represents the coating speed (units: mm/sec), and the ordinate represents the coating width (μm). Note that results have been omitted from FIG. 5 when no coating was achieved with the repair paste 17 or when the coating process was discontinued. In the first example, the electrode line width that was to be repaired was 100 μm. Therefore, as shown in FIG. 5, with the nozzle diameter of 30 μm, sufficient repair was possible at a coating speed of 1 mm/sec. On the other hand, with the nozzle diameter of 50 μm, a coating speed of 4 mm/sec was necessary. Further, when the nozzle diameter was 50 μm, the line width after coating fluctuated remarkably and stable coating was difficult to conduct. When the nozzle diameter was increased to 60 μm, the line width after coating could not be reduced to about 100 μm. Contrary, when a nozzle diameter of less than 20 μm was used, the nozzle was clogged frequently and nozzle replacement frequency was increased. The above results indicate that when the disconnection defects of the electrodes with a line width of about 100 μm are repaired, the nozzle diameter has to be within a range of 20 μm or more to less than 60 μm. Furthermore, stable coating can be achieved with the nozzle diameter within a range of 30 μm or more to less than 50 μm.

### SECOND EXAMPLE

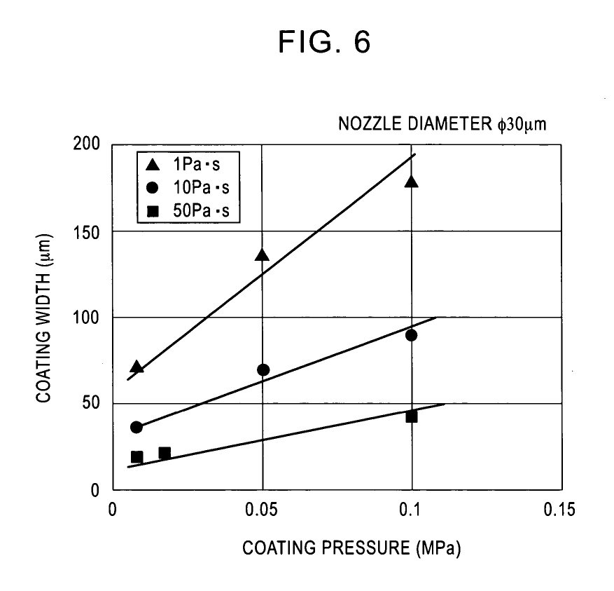

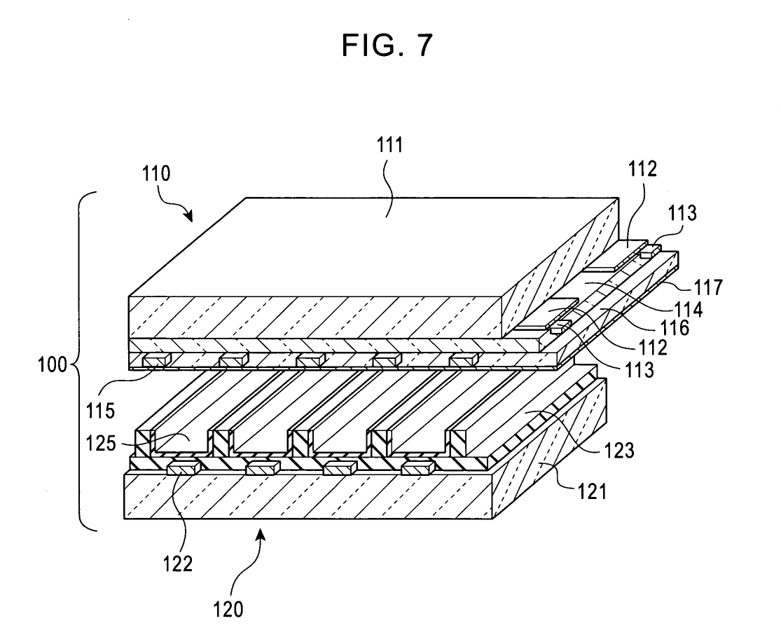

The coating condition was evaluated by varying the viscosity of the repair paste 17 and the coating pressure of the paste in the PDP electrode repair method of the present embodiment. The width and thickness of the address electrode 15 that was repaired were 100 μm and 10 μm, respectively, the height of the coating nozzle 4 above the substrate surface was 40 μm, the inner diameter of the coating nozzle 4 was 30 μm, and the coating speed was 1.0 mm/sec. The coating condition was evaluated in a similar manner as the first example by observing the image from the observation CCD camera 9 with the observation monitor 10 and by measuring the coating width. The results are shown in FIG. 6. When the coating pressure was increased, the line width after coating tended to increase. Furthermore, when the paste viscosity was decreased, the line width after coating tended to increase. When the coating was conduced by using the paste with a viscosity of 1 Pa·sec or less, the ejection rate of the paste was too large, and thus the line width increased. Accordingly, the adjacent electrodes were short circuited. Furthermore, if the portions with the expanded line width were locally present in the wiring, the electric field concentration occurred in those portions during voltage application and the migration phenomenon of Ag particles was easily enhanced, even though resolution of electrode wiring was low and the short circuit condition was not reached. The migration phenomenon of Ag particles can lead to wiring short circuit and produces an adverse effect on quality and reliability. When coating was conducted by using the paste with a viscosity of 60 Pa·sec or more, the nozzle was clogged frequently. The above-described results indicate that when the disconnection defects of electrodes with a line width of about 100 μm are repaired, the paste viscosity has to be within a range of 10 Pa·sec or more to 50 Pa or less.

### THIRD EXAMPLE

The coating condition was evaluated by varying the height of coating nozzle 4 above the substrate surface (hereinafter referred to as “gap clearance”) and coating speed in the PDP electrode repair method of the present embodiment. The width and thickness of the address electrode 15 that was repaired were 100 μm and 10 μm, respectively, the inner diameter of the coating nozzle 4 was 30 μm, the coating pressure was 0.05 MPa, and the paste viscosity was 10 Pa·sec. The coating condition was evaluated in a similar manner as the first example by observing the image from the observation CCD camera 9 with the observation monitor 10 and measuring the coating width. The results are shown in Table 1.

TABLE 1

| GAP | | | | | |
|---|---|---|---|---|---|
| CLEARANCE | COATING SPEED [mm/sec] | | | | |
| [μm] | 0.1 | 0.5 | 1 | 1.5 | 2 |
| 18 | X | X | X | X | X |
| 20 | ◯ | ◯ | ◯ | ◯ | ◯ |
| 30 | | | | | ◯ |
| 40 | | | | | ◯ |
| 50 | | | | | X |
| 60 | | ◯ | ◯ | ◯ | |
| 70 | | ◯ | X | X | |
| 80 | ◯ | X | | | |
| 90 | ◯ | | | | |
| 100 | X | | | | |

With a gap clearance of 18 μm, the coating nozzle 4 was brought into contact with the electrode, and the electrode surface and the distal end of the coating nozzle 4 were damaged. On the other hand, when the gap clearance was increased, coating of the paste on the substrate became intermittent or no coating could be conducted at all. When the gap clearance was 100 μm or more, good coating condition was difficult to obtain even when the coating speed was lowered to 0.1 mm/sec. Further, when the gap clearance was 70 μm or more, a good coating condition could not be obtained unless the coating speed was reduced to 0.5 mm/sec or less. The above results indicate that when disconnection defects of electrodes with a line width of about 100 μm are repaired, the gap clearance has to be within a range from 20 μm or more to less than 100 μm. Even better coating condition is obtained with a range of 20 μm or more to less than 70 μm.

### FOURTH EXAMPLE

The coating condition was evaluated by varying the mean particle diameter of Ag particles contained in the repair paste 17 in the PDP electrode repair method of the present embodiment. The width and thickness of the address electrode 15 that was repaired were 100 μm and 10 μm, respectively, the height of the coating nozzle 4 above the substrate surface was 40 μm, the inner diameter of the coating nozzle 4 was 30 μm, the coating pressure was 0.05 MPa, the coating speed was 1.0 mm/sec, and the paste viscosity was 10 Pa·sec. The coating condition was evaluated depending on the presence or absence of nozzle clogging during coating. Further, the condition was evaluated by observing the image from the observation CCD camera 9 with the observation monitor 10 and by measuring the coating width before and after drying and baking. The results are shown in Table 2.

TABLE 2

| | | | | | MEAN | | |
|---|---|---|---|---|---|---|---|
| NOZZLE | COATING | GAP | COATING | PASTE | PARTICLE | COATABILITY | CONDITION |
| DIA. | PRESS. | CLEARANCE | SPEED | VISC. | DIAMETER | (NOZZLE | AFTER |
| [μm] | [MPa] | [μm] | [mm/s] | [Pa · s] | [μm] | CLOGGING) | BAKING |
| 30 | 0.1 | 40 | 1 | 10 | 0.07 | ◯ | X |
| 30 | 0.1 | 40 | 1 | 10 | 0.1 | ◯ | Δ |
| 30 | 0.1 | 40 | 1 | 10 | 0.3 | ◯ | ◯ |
| 30 | 0.1 | 40 | 1 | 10 | 0.5 | ◯ | ◯ |
| 30 | 0.1 | 40 | 1 | 10 | 0.8 | ◯ | ◯ |
| 30 | 0.1 | 40 | 1 | 10 | 1 | Δ | ◯ |
| 50 | 0.1 | 40 | 1 | 10 | 1 | Δ | ◯ |
| 50 | 0.2 | 40 | 1 | 10 | 1 | Δ | Δ |

When coating was conducted with the paste using Ag particles whit a mean particle diameter of 0.07 μm, the coating condition prior to drying and baking was good, but drying and baking decreased the thickness and increased the width of the paste evaluation of the condition after baking was×). When the mean particle diameter was 0.1 μm, the coatability was good, but the line width was increased to a certain extent after baking (evaluation was Δ). On the other hand, when the mean particle diameter was 1.0 μm, the nozzle was clogged frequently evaluation was Δ), but the condition after baking was good (evaluation was ◯). The same results were obtained even when the inner diameter of the coating nozzle 4 was increased to 50 μm. Furthermore, even when the coating pressure was raised to 0.2 MPa, the nozzle clogging could not be improved and when coating was skillfully conducted, the coating rate was conversely increased and the line width increased (evaluation was Δ). The above results indicate that when disconnection defects of electrodes with a line width of about 100 μm are repaired, the mean particle diameter of Ag particles contained in the repair paste 17 has to be within a range from 0.1 μm or more to less than 1.0 μm. Even better coating condition is obtained with a range of 0.3 μm or more to less than 1.0 μm.

This application is based on Japanese Patent Application No. 2004-106887 which is herein incorporated by reference.

1. An electrode repair method for a plasma display comprising:
placing a glass substrate of the plasma display on a stage;
specifying a disconnection defect zone of an electrode by observing a surface of the glass substrate of the plasma display;
measuring a distance H between a distal end of a coating nozzle section in a dispenser coating apparatus including the coating nozzle section and a syringe section and the surface of the glass substrate of the plasma display;
disposing the coating nozzle section so that a distance (H−T) obtained by subtracting a thickness T of the electrode from the distance H becomes a predetermined value or more;
linearly coating the disconnection defect zone of the electrode with an electrically conductive paste by ejecting the paste from the coating nozzle section, while scanning the dispenser coating apparatus in a horizontal direction; and
repairing the disconnection defect zone of the electrode by drying and baking the electrically conductive paste.

2. The electrode repair method for the plasma display according to claim 1, wherein measuring the distance H is conducted by irradiating the glass substrate with a laser beam from an oscillator fixed to the coating nozzle section, receiving a reflected light obtained by the reflection of the laser beam on the surface of the glass substrate with a light receiving section fixed to the coating nozzle section, and measuring the intensity of the received reflected light.

3. The electrode repair method for the plasma display according to claim 1, wherein measuring the distance H is conducted by moving a probe in a direction toward the glass substrate and detecting a position of the probe at a time the probe is brought into contact with the glass substrate.

4. The electrode repair method for the plasma display according to claim 1, wherein drying and baking of the electrically conductive paste is conducted with a heat source or laser beam source.

5. The electrode repair method for the plasma display according to claim 1, wherein the electrically conductive paste includes at least one type selected from metal fine particles of Ru, Cr, Fe, Co, Mn, Cu and oxides thereof and is colored gray.

6. The electrode repair method for the plasma display according to claim 1, wherein an inner diameter of the distal end of the coating nozzle section is 20 μm or more to less than 60 μm.

7. The electrode repair method for the plasma display according to claim 6, wherein an inner diameter of the distal end of the coating nozzle section is 30 μm or more to less than 50 μm.

8. The electrode repair method for the plasma display according to claim 1, wherein the viscosity of the electrically conductive paste is 10 to 50 Pa·sec.

9. The electrode repair method for the plasma display according to claim 1, wherein a distance H between the distal end of the coating nozzle section and the surface of the glass substrate of the plasma display is 20 μm or more to less than 100 μm.

10. The electrode repair method for the plasma display according to claim 9, wherein the distance H between the distal end of the coating nozzle section and the surface of the glass substrate of the plasma display is less than 70 μm.

11. The electrode repair method for the plasma display according to claim 1, wherein the electrically conductive particles of the electrically conductive paste include 50% or more in weight of the Ag particles with a mean particle diameter of 0.1 μm or more to less than 1.0 μm.

12. The electrode repair method for the plasma display according to claim 11, wherein the mean particle diameter of the Ag particles is 0.3 μm or more.

13. An electrode repair apparatus for a plasma display comprising:
a stage for placing a glass substrate of the plasma display;
a camera for picking up an image of a surface of the glass substrate of the plasma display;
a display unit for displaying the image picked up with the camera;
a dispenser coating apparatus including a syringe section filled with an electrically conductive paste and a coating nozzle section for ejecting the electrically conductive paste;
a pressurization control apparatus for pressurizing an inside of the syringe section and ejecting the electrically conductive paste from the coating nozzle section;
a measurement device for measuring a distance between a distal end of the coating nozzle section and a surface of the glass substrate of the plasma display;
a baking device for drying and baking the electrically conductive paste after coating;
a drive apparatus for driving the camera, the dispenser coating apparatus, the measurement device, and the baking apparatus in a vertical direction and a horizontal direction; and
a control apparatus for controlling the drive apparatus so as to linearly coat a disconnection defect zone of an electrode on the surface of the glass substrate of plasma display with the electrically conductive paste.

14. The electrode repair apparatus for the plasma display according to claim 13, wherein the measurement device irradiates the glass substrate with a laser beam from an oscillator fixed to the coating nozzle section, receives a reflected light obtained by the reflection of the laser beam on the surface of the glass substrate with a light receiving section fixed to the coating nozzle section, and measures the intensity of the received reflected light.

15. The electrode repair apparatus for the plasma display according to claim 13, wherein the measurement device moves a probe in a direction toward the glass substrate and detects a position of the probe at a time the probe is brought into contact with the glass substrate.

16. The electrode repair apparatus for the plasma display according to claim 13, wherein the baking apparatus heats the electrically conductive paste with a heat source or laser beam source.

17. The electrode repair apparatus for the plasma display according to claim 13, wherein the electrically conductive paste includes at least one type selected from metal fine particles of Ru, Cr, Fe, Co, Mn, Cu and oxides thereof and is colored gray.

18. The electrode repair apparatus for the plasma display according to claim 13, wherein an inner diameter of the distal end of the coating nozzle section is 20 μm or more to less than 60 μm.

19. The electrode repair apparatus for the plasma display according to claim 18, wherein an inner diameter of the distal end of the coating nozzle section is 30 μm or more to less than 50 μm.

20. The electrode repair apparatus for the plasma display according to claim 13, wherein the viscosity of the electrically conductive paste is 10 to 50 Pa·sec.

21. The electrode repair apparatus for the plasma display according to claim 13, wherein a distance H between the distal end of the coating nozzle section and the surface of the glass substrate of the plasma display is 20 μm or more to less than 100 μm.

22. The electrode repair apparatus for the plasma display according to claim 21, wherein the distance H between the distal end of the coating nozzle section and the surface of the glass substrate of the plasma display is less than 70 μm.

23. The electrode repair apparatus for the plasma display according to claim 13, wherein the electrically conductive particles of the electrically conductive paste include 50% or more in weight of the Ag particles with a mean particle diameter of 0.1 μm or more to less than 1.0 μm.

24. The electrode repair apparatus for the plasma display according to claim 23, wherein the mean particle diameter of the Ag particles is 0.3 μm or more.
